(19) United States
(12) Patent Application Publication
(10) Pub. No.: US 2017/0243489 A1
(43) Pub. Date: Aug. 24, 2017

(54) Vehicle Backing System

(71) Applicant: Fabricio Mariotto, Westchester, CA (US)

(72) Inventor: Fabricio Mariotto, Westchester, CA (US)

(21) Appl. No.: 15/049,802

(22) Filed: Feb. 22, 2016

(51) Int. Cl. G08G 1/16; B60R 1/00; H04N 7/18

(52) U.S. Cl. CPC G08G 1/16; H04N 7/183; B60R 1/00

(57) ABSTRACT

A vehicle backing system includes a vehicle that has a back side. A frame is removably coupled to the back side. An electronic device is provided and the electronic device may be held. A video unit is coupled to the frame. The video unit records video footage of an area adjacent to the back side. The video unit is in electrical communication with the electronic device. Thus, the electronic device may display the video footage thereby facilitating the vehicle to be backed into the area.

### BACKGROUND OF THE DISCLOSURE

### Field of the Disclosure

The disclosure relates to vehicle backing devices and more particularly pertains to a new vehicle backing device for facilitating a smart phone to be in communication with a back up camera on a vehicle.

### SUMMARY OF THE DISCLOSURE

An embodiment of the disclosure meets the needs presented above by generally comprising a vehicle that has a back side. A frame is removably coupled to the back side. An electronic device is provided and the electronic device may be held. A video unit is coupled to the frame. The video unit records video footage of an area adjacent to the back side. The video unit is in electrical communication with the electronic device. Thus, the electronic device may display the video footage thereby facilitating the vehicle to be backed into the area.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a vehicle backing system according to an embodiment of the disclosure.

FIG. 2 is a right side view of an embodiment of the disclosure.

FIG. 3 is a front view of an embodiment of the disclosure.

FIG. 4 is a perspective in-use view of an embodiment of the disclosure.

FIG. 5 is a schematic view of an embodiment of the disclosure.

### DESCRIPTION OF THE PREFERRED EMBODIMENT

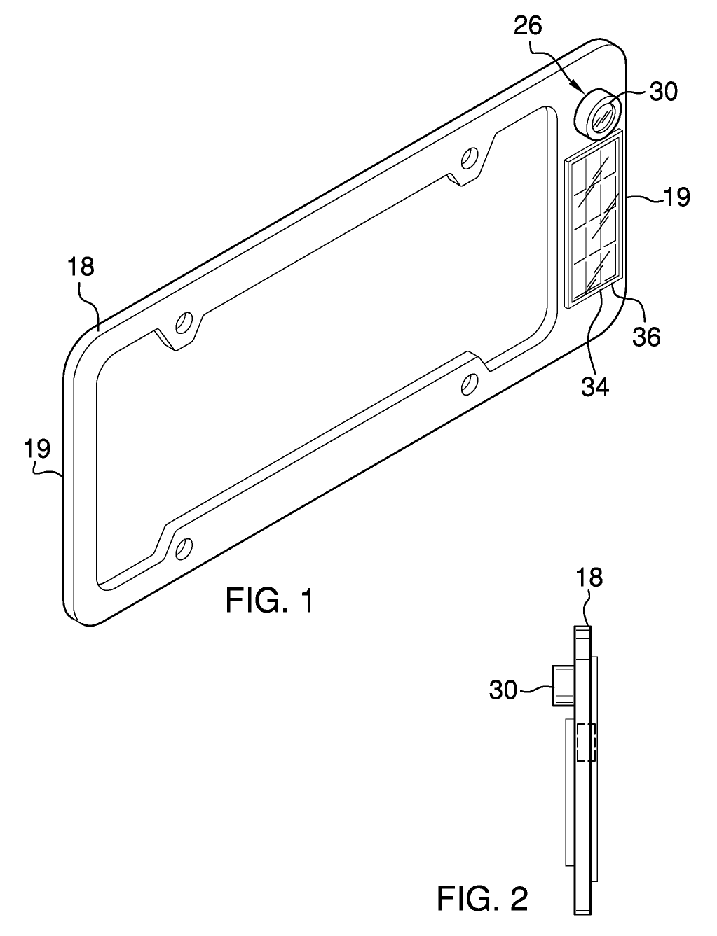

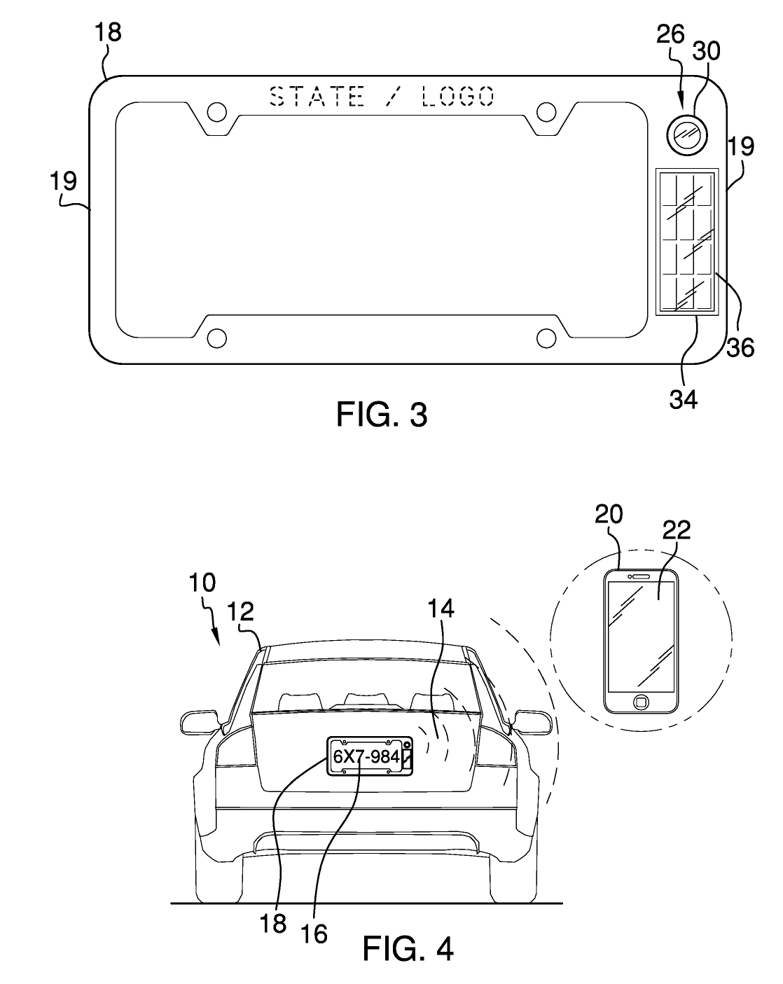

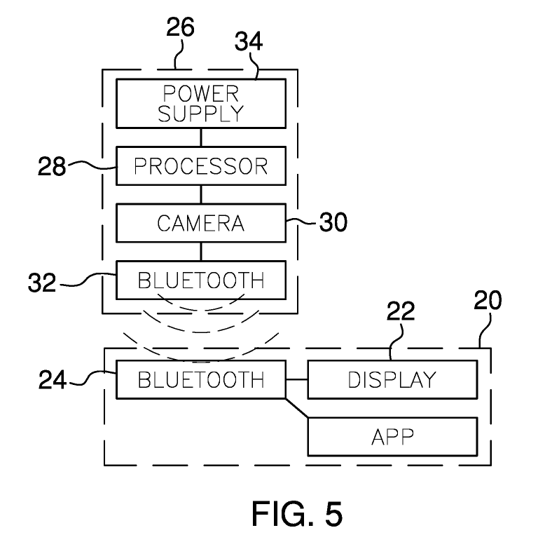

With reference now to the drawings, and in particular to FIGS. 1 through 5 thereof, a new vehicle backing device embodying the principles and concepts of an embodiment of the disclosure and generally designated by the reference numeral 10 will be described.

As best illustrated in FIGS. 1 through 5, the vehicle backing system 10 generally comprises a vehicle 12 that has a back side 14 and a license plate 16 that is coupled to the back side 14. The vehicle 12 may comprise a passenger vehicle or the like. A frame 18 is removably coupled to the back side 14 such that the frame 18 surrounds the license plate 16. The frame 18 may have a pair of longitudinal arms 19 and the frame 18 may comprise a license plate frame of any conventional design.

An electronic device 20 is provided and the electronic device 20 may be held. The electronic device 20 has a display 22 and a first transceiver 24. The display 22 is electrically coupled to the first transceiver 24. The electronic device 20 may comprise a smart phone or the like. Additionally, the smart phone may store an app or the like.

A video unit 26 is coupled to the frame 18. The video unit 26 may record video footage of an area adjacent to the back side 14. The video unit 26 is in electrical communication with the electronic device 20. Thus, the electronic device 20 may display the video footage thereby facilitating the vehicle 12 to be backed into the area. The video unit 26 may be positioned on one of the longitudinal arms 19 of the frame 18.

The video unit 26 comprises a processor 28 that is coupled to the frame 18. The processor 28 may comprise an electronic processor or the like. A video camera 30 is coupled to the frame 18 such that the video camera 30 is directed away from the back side 14. Thus, the video camera 30 may record the video footage of the area adjacent to the back side 14. The video camera 30 is electrically coupled to the processor 28. The video camera 30 may comprise a digital video camera or the like.

A second transceiver 32 is coupled to the frame 18 and the second transceiver 32 is electrically coupled to the processor 28. Thus, the second transceiver 32 receives the video footage from the video camera 30. The second transceiver 32 is in electrical communication with the first transceiver 24. Thus, the display 22 may display the video footage. The second transceiver 32 may comprise a radio frequency transceiver or the like. Additionally, the second transceiver 32 may utilize a Bluetooth signal or the like.

A power supply 34 is coupled to the frame 18 and the power supply 34 is electrically coupled to the processor 28. The power supply 34 comprises at least one solar cell 36. The processor 28 may be electrically coupled to the vehicle 12. Thus, the vehicle 12 may supply electrical power to the processor 28 when the solar cell 36 is not exposed to sunlight.

In use, the display 22 on the electronic device 20 is observed when the vehicle 12 is being backed up. The app is manipulated on the electronic device 20 such that the electronic device 20 is synched with the video unit 26. The display 22 on the electronic device 20 displays the video footage. Thus, the vehicle 12 may be backed into the area without striking an object. The electronic device 20 eliminates the need to have a display permanently mounted in the vehicle 12.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vehicle backing system comprising:
a vehicle having a back side and a license plate being coupled to said back side;
a frame being removably coupled to said back side such that said frame surrounds said license plate;
an electronic device being configured to be held; and
a video unit being coupled to said frame wherein said video unit is configured to record video footage of an area adjacent to said back side, said video unit being in electrical communication with said electronic device wherein said electronic device is configured to display the video footage thereby facilitating said vehicle to be backed into the area.

2. The system according to claim 1, wherein said video unit comprises:
a processor being coupled to said frame; and
a video camera being coupled to said frame such that said video camera is directed away from said back side wherein said video camera is configured to record the video footage, said video camera being electrically coupled to said processor.

3. The system according to claim 2, further comprising a second transceiver being coupled to said frame, said second transceiver being electrically coupled to said processor such that said second transceiver receives the video footage from said video camera, said second transceiver being in electrical communication with said first transceiver wherein said display is configured to display the video footage.

4. The system according to claim 1, further comprising:
a processor; and
a power supply being coupled to said frame, said power supply being electrically coupled to said processor, said power supply comprising at least one solar cell.

5. A vehicle backing system comprising:
a vehicle having a back side and a license plate being coupled to said back side;
a frame being removably coupled to said back side such that said frame surrounds said license plate;
an electronic device being configured to be held, said electronic device having a display and a first transceiver, said display being electrically coupled to said first transceiver; and
a video unit being coupled to said frame wherein said video unit is configured to record video footage of an area adjacent to said back side, said video unit being in electrical communication with said electronic device wherein said electronic device is configured to display the video footage thereby facilitating said vehicle to be backed into the area, said video unit comprising:
a processor being coupled to said frame,
a video camera being coupled to said frame such that said video camera is directed away from said back side wherein said video camera is configured to record the video footage, said video camera being electrically coupled to said processor,
a second transceiver being coupled to said frame, said second transceiver being electrically coupled to said processor such that said second transceiver receives the video footage from said video camera, said second transceiver being in electrical communication with said first transceiver wherein said display is configured to display the video footage, and
a power supply being coupled to said frame, said power supply being electrically coupled to said processor, said power supply comprising at least one solar cell.
